(19) United States
(12) Patent Application Publication
(10) Pub. No.: US 2004/0267626 A1
(43) Pub. Date: Dec. 30, 2004

(54) Internet based service (IBS)

(76) Inventor: Bruce N. Rosenthal, Magnolia, TX (US)

Correspondence Address: David M. Ostfeld, Chamberlain, Hrdlicka, White, Williams & Martin, Suite 1400, 1200 Smith Street, Houston, TX, 77002, US

(21) Appl. No.: 10/606,993

(22) Filed: Jun. 26, 2003

(51) Int. Cl. G06F 17/60

(52) U.S. Cl. 705/26

(57) ABSTRACT

A process is disclosed which combines Internet technology and organizational business practices, to enable a service provider to become the central procurement department for multiple companies by purchasing goods and services from an aggregation of multiple companies. This is accomplished by offering the services of purchasing goods and services to a subset of the purchasing public who are tenants of member office buildings.

### BACKGROUND

1. Field of the Invention

The invention relates to processes for central procurement of goods and services and more particularly central procurement of goods and services for an aggregation of multiple companies.

2. Description of the Prior Art

Central procurement of goods and services is known. Usually it is applied to a single company purchasing for all its needs. However, recent technology has permitted the existence of on-line stores such as Amazon which are open to all buyers having no commonality except the desire to purchase the goods offered by the store. The store Amazon, for example, thus maintains an inventory to satisfy on-line orders. The on-line store usually has one provider who has purchased the entire inventory and resells it.

On-line buying services and buying co-ops also exist. These on-line buyers and membership clubs, such as co-ops, deal with conventional commonalities such as a Standard Industry Classification (SIC) or personal interest or hobbies or an individual function within an organization or educational background. This type of service provider normally acts on behalf of the buyer in the model of a “club”. Commissions are paid to the “club” which does not own the property but is charged for facilitating the purchase. Also membership fees may be required. The purchasers have very little influence or control over such a service provider.

### SUMMARY OF THE INVENTION

The invention provides a process which through the combination of internet technology and organizational business practices, the service provider becomes the central procurement department for multiple companies by purchasing goods and services for an aggregation of multiple companies. This is accomplished by offering the service of purchasing goods and services to a subset of the purchasing public who are tenants of member office buildings. By creating an organizational, structural and operating framework for purchasing goods and services the service provider may transform individual disparate tenants into a part of a Virtual Corporation for purchasing purposes which is built and managed by the service provider. By analogy, each building could be considered a separate facility of the Virtual Corporation, and each tenant organization, such as a company, in the building would be considered a separate department or division in the Virtual Corporate facility. Thus, the service provider becomes the consolidated central procurement department for such an entire Virtual Corporation. It aggregates the purchasing power of all such tenants to provide the goods and services required at preferential proprietary pricing. Substantial cost savings are thus created for all individual disparate tenants of the building (6) who subscribe to the service. The service is an Internet based service that facilitates the ordering and delivery of goods and services organized around an Internet based order engine/catalog much like the net-based catalog of centrally procured goods offered by large corporations to their divisions; however, unlike a single corporation the tenants are not part of a larger legal entity and on their own could not obtain the benefits that exist due to the superstructure created by the service provider. The service provider is synthetically creating an organization that provides for the aggregation of many office tenants' purchases of goods and services from multiple providers, allowing for negotiation of lower prices than would be available to the individual companies.

### BRIEF DESCRIPTION OF THE DRAWING

For further understanding of the nature and objects of the present invention, reference should be had to the following FIGURE in which like parts are given like reference numerals and wherein:

FIG. 1 is an illustration of the flow of transactions and goods and services through the process and system of the preferred embodiment of the present invention.

### DESCRIPTION OF THE PREFERRED EMBODIMENT

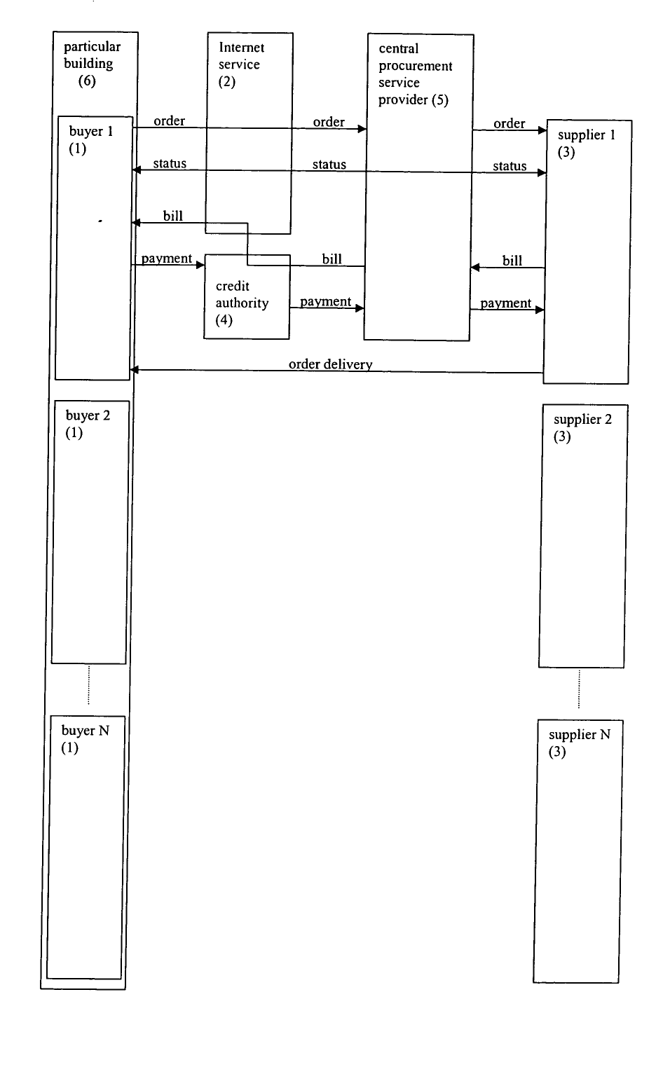

As shown in FIG. 1, a large number of buyers (1) connect to an Internet service (2) through which they acquire goods and services such as office supplies, airline reservations, and rental cars. The Internet service (2) would preferably be a restricted internal portal with preferably access limited to tenants of a particular building (6). A central procurement service provider (5) for the Internet service (2) would negotiate with third party suppliers (3), which could be any of a manufacturer or distributor or other supplier or intermediary to obtain the best prices on goods and services. The provider (5) would operate the restricted Internet (2) portal with access limited to tenants of the particular building (6). Such a portal (2) would be available for each of multiple buildings (6). Once the procurement provider (5) and a supplier (3) have agreed on selected offerings and terms, the Internet portal (2) would have a link invisible to the tenants of the building (6) who are the buyers (1). This link would permit the service provider (5) to integrate the particular offerings from a specific supplier (3) with those from other suppliers (3) and display those to buyers (1) through the Internet service (2). The name of the supplier (3) would be preferably withheld from the buyers (1) to permit the servicer provider (5) to maintain management control over all offerings and set pricing and to make a profit.

The Internet purchasing system provides a connection to the suppliers (3) in three different ways depending on the design of the supplier's data systems. These methods are:

1. Direct connection to the supplier's catalog.

2. Hosting a duplicate of the supplier's catalog with update via electronic data interchange (EDI) message or extended markup language (XML) message.

3. Transmitting the information necessary to request a quote or reservation to the supplier as EDI to XML.

Payment is made to the supplier (3) by the service provider (5). The service provider (5) collects payment from the buyers (1) using a credit authority (4) (e.g. MasterCard, Visa, American Express, or Debit Card) preferably at time of order. The service provider (5) provides for aggregation of the purchases from all suppliers (3) into a single invoice and online payment record. Prices to the buyers (1) are set by the service provider (5). Prices from the supplier (3) are negotiated by the service provider (5) as set out above. Payment thus flows from buyers (1) through credit authority (4) to service provider (5) and then by service provider (5) to suppliers (3).

As indicated above, the method of doing business of the present invention is distinguished from prior art methods in the following ways:

From an online store (e.g. Amazon):

1. It is not an open portal where anyone can login and place orders.

2. The service provider (5) has created unique bonds and commonality between buyers (1).

3. Potential buyers (1) must have an affiliation to a specific physical address (6) that the service provider (5) has agreed to include in this system. The service provider's (5) agreement with the buyers (1) is conditioned on the agreement that the service provider (5) has made with the supplier (3) for the consolidation of deliveries to this address (6).

4. The service provider (5) maintains no inventory.

5. Payment to the supplier (3) is made by the service provider (5) on terms it negotiates.

6. The service provider (5) explicitly represents itself as an interface to multiple distinct suppliers (3), and is operating on behalf of the buyers (1) to obtain lower prices.

7. The service provider (5) assumes responsibility for order fulfillment and delivery either without assuming ownership of the goods at any time or assuming such ownership. Preferably, the service provider (5) does assume responsibility for ensuring the goods and services are actually delivered and are of the quality and quantity contracted for and expected.

8. There is no supplier (3) or other third party separately advertising on the site.

9. The service provider (5) assumes the responsibility and role for customer service and fulfillment between the buyer (1) and the supplier (3).

From an online buying service (e.g. Buy.com):

1. The service provider (5) has created a unique series of bonds and commonality between buyers (1). These are not based on any of the conventional commonalities (e.g. common Standard Industry Classification (SIC), individual function within an organization (e.g. administrative personnel, or financial officers), personal interest, hobby, or educational background (e.g. golf, science fiction, university affinity).

2. The service provider (5) acts on behalf of the buyers (1) in the model of a buyers “club”.

3. There is no association or membership fee or organization.

4. The Internet service provider (5) is not receiving a commission or fee from sellers (3).

5. The Internet service provider (5) controls both the price it pays to suppliers (3) and charges buyers (1).

6. The buyers (1) have no approval, influence or control over the service provider (5).

From a buying co-op:

1. The service provider (5) is a business operating for profit solely for its own account.

2. The buyers (1) have no legal right of influence over the service provider (5), and have no right to participation profits of service provider (5).

3. The service provider (5) has recognized and created the unique bonds that allow for buyers (1) to participate and make purchases, but the buyers are not “members”.

4. The service provider (5) has sole ability to determine who can become a buyer (1).

5. The buyers (1) will not all have any of the commonality bonds generally associated with co-op members.

In the system:

1. The tenant or buyer (1) would be paying a price determined by the service provider (5).

2. The website or Internet service (2) would obtain authorization for charge from the buyer (1) credit card and receive payment (4).

3. The website or Internet service (2) would confirm the order and delivery with the supplier (3).

4. The Internet service (2) would send an e-mail confirmation to the purchaser/tenant/buyer (1).

5. The buyer (1) would regard the service provider (5) the website to be that of the merchant or purchase facilitator for the goods and services obtained.

6. Resolution of issues relating to order fulfillment and customer (1) satisfaction are the responsibility and obligation of service provider (5) via the Internet service website (2).

7. From the perspective of the vendor or supplier (3) the service provider (5) is the purchaser or purchase facilitator.

In this manner the service provider (5) represents a significant predictable single source of demand. Suppliers (3) would not have to deal with credit risks, billing or collection activities generally associated with individually attempting to supply the tenant base (1) which has been replaced by or represented by the service provider (5). In addition, the cost of delivery of suppliers (3) is greatly reduced, due to the fact that the customers/tenants (1) are concentrated in one large location (a building (6)) allowing the supplier (3) to ship goods in large quantities and consolidate delivery to a single address, preferably individually packed and addressed at the building (6). In addition, cost of customer service is greatly reduced because the service provider (5) would act as the customer service center, ensuring the supplier (3) interfaces with only one point of contact.

Thus, through this structure, unrelated and individual buyers (1) are being offered through the organization and super structure of the service provider (5) the ability to act as if they were all part of a large corporation able to benefit from a service provider (5) negotiating, contracting, and managing the delivery, fulfillment and customer service functions with suppliers (3) and thus synthetically creating a virtual corporation centralized procurement function.

Because many varying and different embodiments may be made within the scope of the invention concept taught herein which may involve many modifications in the embodiments herein detailed in accordance with the descriptive requirements of the law, it is to be understood that the details herein are to be interpreted as illustrative and not in a limiting sense.

What is claimed as invention is:

1. A process of purchasing goods and services by a service provider comprising:
A. organizing a set of customers desirous of purchasing at least some of the goods or services, such customers taken from tenant organizations housed in a building structure to purchase from a central source, said organizing including arranging for communication between the service provider and each of the set of customers by computer controlled electronic communication;
B. locating at least one supplier having at least some of the goods or services;
C. transmitting the available goods or services of the supplier to the set of customers at prices set by the service provider;
D. receive orders from the customers;
E. combine the customer orders to a consolidated order for the supplier;
F. ordering the customer orders from the supplier;
G. paying the supplier for the customer orders;
H. charging the customers for their respective orders;
I. receiving goods and services from the supplier; and
J. distributing the goods and services to the customer.

2. The process of claim 1, wherein there is further included in Step D the step of confirming the order.

3. The process of claim 1, wherein Step I includes confirming delivery to the supplier.

4. The process of claim 1, wherein there is further included in Step J the step of confirming delivery to the customer.

5. The process of claim 1, wherein Step B includes locating multiple suppliers and Step B includes combining the customer orders to a consolidated order for each of the suppliers and Step F includes ordering the customer orders from the suppliers and Step G includes the step of paying the suppliers for the customer orders and Step I includes receiving goods and services from the suppliers.

6. The process of claim 1, wherein Step A includes organizing a limited set of customers desirous of purchasing at least some of the goods or services, such customers taken from tenant organizations housed in building structures to purchase from a central source.

7. The process of claim 1, wherein Step C includes the step of producing a catalog of available goods and services and transmitting the available goods or services in the catalog to the set of customers at prices set by the service provider.

8. The process of claim 1, wherein the set of customers is a small closed set.

9. The process of claim 1, wherein the electronic communication is by Internet service.

10. The process of claim 1, wherein the electronic communication is by restricted internal portal.

11. The process of claim 1, wherein the electronic communication is by restricted internal portal, the restricted internal portal being restricted to customers located in the building structure.

12. The process of claim 1, wherein the electronic communication is by restricted internal portal, the restricted internal portal being invisible to the customers in the building structure.

13. The process of claim 1, wherein the customers are various corporations.

14. The process of claim 1, wherein the building structure is a single building.

15. The process of claim 1, wherein there is included the step of negotiating by the service provider with the supplier for the best pricing for volume.

16. The process of claim 1, wherein there is included within Step A the step of assembling the needs of the customers to locate the supplier.

17. The process of claim 1, wherein Step C includes withholding the name of the supplier from the customer.

18. The process of claim 1, wherein Step F includes ordering the customer orders from the supplier, inventory free to the service provider.

19. The process of claim 1, wherein Steps E, F and G are performed by computer controlled electronic communication.

20. The process of claim 1, wherein Step C includes the service provider solely setting the prices.

21. The process of claim 1, wherein Step G occurs after Step D and before Step E.

22. The process of claim 1, wherein there is included the further step of the service provider providing customer service and fulfillment service.
